(19) United States
(12) Patent Application Publication
(10) Pub. No.: US 2003/0204724 A1
(43) Pub. Date: Oct. 30, 2003

(54) Methods for remotely changing a communications password

(75) Inventors: Arun Ayyagari, Seattle, WA (US); Krishna Ganugapati, Redmond, WA (US); Timothy M. Moore, Bellevue, WA (US); Daniel R. Simon, Redmond, WA (US); Pradeep Bahl, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/135,043

(22) Filed: Apr. 30, 2002

(51) Int. Cl. H04L 9/00

(52) U.S. Cl. 713/168

(57) ABSTRACT

Disclosed are methods for an authentication client, having been authenticated by an authentication server, to leverage the effects of that authentication to implement a new communications password. The authentication client gets a new password from its user. From the new password and from information provided by the authentication server, the authentication client derives a “password verifier.” The password verifier is then shared with the authentication server. The new password itself is never sent to the authentication server, and it is essentially impossible to derive the new password from the password verifier. The authentication client and the authentication server, in parallel, derive a new set of authentication and encryption security keys from the new password and from the password verifier, respectively. This process may be repeated to limit the amount of data sent using any one particular set of security keys and thus to limit the effectiveness of any statistical attacker.

### TECHNICAL FIELD

The present invention is related generally to computer communications, and, more particularly, to providing password-based security to computer communications sessions.

### BACKGROUND OF THE INVENTION

Computer networks are growing larger and are carrying much more sensitive information. For security's sake, a computing device using a network often proves its identity (“authenticates itself”) to other devices and only communicates sensitive information with other authenticated devices. However, the vast majority of authenticated communications are still vulnerable to security attacks. In one form of security attack, an attacker is erroneously authenticated, possibly by impersonating a legitimate device. Once authenticated, the attacker has access to information meant only for legitimately authenticated devices. In a second form of attack, the attacker is not authenticated, but eavesdrops on communications among authenticated devices in order to obtain security codes. With those security codes in hand, the eavesdropper can access sensitive information sent by the authenticated devices. These security attacks are especially worrisome to devices that communicate via wireless technologies because it is difficult or impossible to restrict physical access to their communications.

These two forms of security attacks are addressed by two major aspects of communications security. First, authentication techniques are becoming increasingly sophisticated to prevent their use by illegitimate attackers. A typical communications environment contains an authentication server that communicates with all computing devices (called “authentication clients”) when they attempt to become authenticated. To become authenticated, an authentication client usually must prove its knowledge of some authentication credentials. In some cases, the authentication credentials include a secret communications password shared between the authentication client and the authentication server. In other cases, the authentication credentials may be based upon public/private key pairs and security certificates. In any case, only upon proving its knowledge of the authentication credentials is the authentication client authenticated to the authentication server. The authentication process is usually mutual, with the authentication server also proving its identity to the authentication client.

In a second aspect of communications security, information transmitted among authenticated computing devices is encrypted. In a typical encryption method, the information sender and the receiver first agree upon an information-encoding scheme. The encoding scheme is based upon secret security keys, often, but not always, shared between the sender and the receiver. The secret security keys may be based upon the same communications password used for authentication. The sender encrypts the information using the agreed-upon encoding scheme and then sends the encrypted information to the receiver. Upon reception, the receiver decrypts the information using the agreed-upon encoding scheme. Although the encrypted information may still be eavesdropped, the eavesdropper cannot obtain the original information without knowing the security keys.

However, authentication and encryption do not always provide sufficient protection. For example, encrypted information is still subject to a number of attacks, including statistical attacks. In a statistical attack, an eavesdropper analyzes a set of encrypted messages in order to tease out patterns that are associated with the security scheme agreed upon by the sender and the receiver. From the patterns, the eavesdropper may discover the security keys underlying the agreed-upon security scheme and use them to decrypt the encrypted information.

Because of the statistical nature of this method of attack, its accuracy improves with an increasing number of messages analyzed. Thus one approach to frustrate statistical attacks is to limit the amount of information sent using any one security scheme. To do this, the security keys underlying the agreed-upon security scheme may be changed frequently. The mutual authentication process changes the security keys used by the authentication client and by the authentication server. However, authentication does not alter the fact that the new security keys are still based upon an unchanged communications password. Over time, that password may be compromised, so it too should be frequently changed. This is not as straightforward as it may at first appear. In order to be useful, the new password (or information derived from it) needs to be available both to the authentication client and to the authentication server. Simply setting a new password on the authentication client and then sending it over a communications link to the authentication server is not very secure. “Out-of-band” methods (methods that do not use a computer communications link) of sending the new password, though reasonably secure, may be so burdensome, especially if the authentication server is located far from the authentication client, that they discourage frequent password changes.

What is needed is a non-burdensome way for an authentication client and an authentication server to implement a new communications password without explicitly transmitting the new password over a communications link.

### SUMMARY OF THE INVENTION

In view of the foregoing, the present invention provides a method for an authentication client, having been authenticated by an authentication server, to leverage the effects of that authentication to implement a new communications password. The authentication server requests that the authentication client implement a new password. The authentication client gets a new password from its user. From the new password and from information provided by the authentication server, the authentication client derives a “password verifier.” The password verifier is then shared with the authentication server. During the process of implementing the new password, communications between the authentication client and the authentication server are secured using security keys derived from the previous password. The new password itself is never sent to the authentication server, and it is essentially impossible to derive the new password from the password verifier. For future re-authentications, the authentication server's knowledge of the password verifier and the authentication client's knowledge of the new password itself serve as authentication credentials.

The authentication client and the authentication server, in parallel, derive a new set of security keys from their knowledge of their respective authentication credentials. The new security keys are used for authentication and encryption until the process is repeated and a newer set of security keys is derived from a newer password. This process may be repeated as often as desired to limit the amount of data sent using any one particular set of security keys and thus to limit the effectiveness of any statistical attacker.

In another aspect of the present invention, the authentication server decides when the current communications password should be changed, its decision possibly based upon the passage of time or upon the amount of data sent using the current password.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram showing an exemplary communications environment with an authentication client, an authentication server, and an eavesdropper;

FIG. 2 is schematic diagram generally illustrating an exemplary computing system that supports the present invention;

FIGS. 3a through 3c together form a dataflow diagram generally showing the information passed and the operations performed when an authentication client and an authentication server mutually authenticate each other and then implement a new communications password according to one embodiment of the present invention; and

FIG. 4 is a data structure diagram showing possible messages used during the process of implementing a new communications password.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

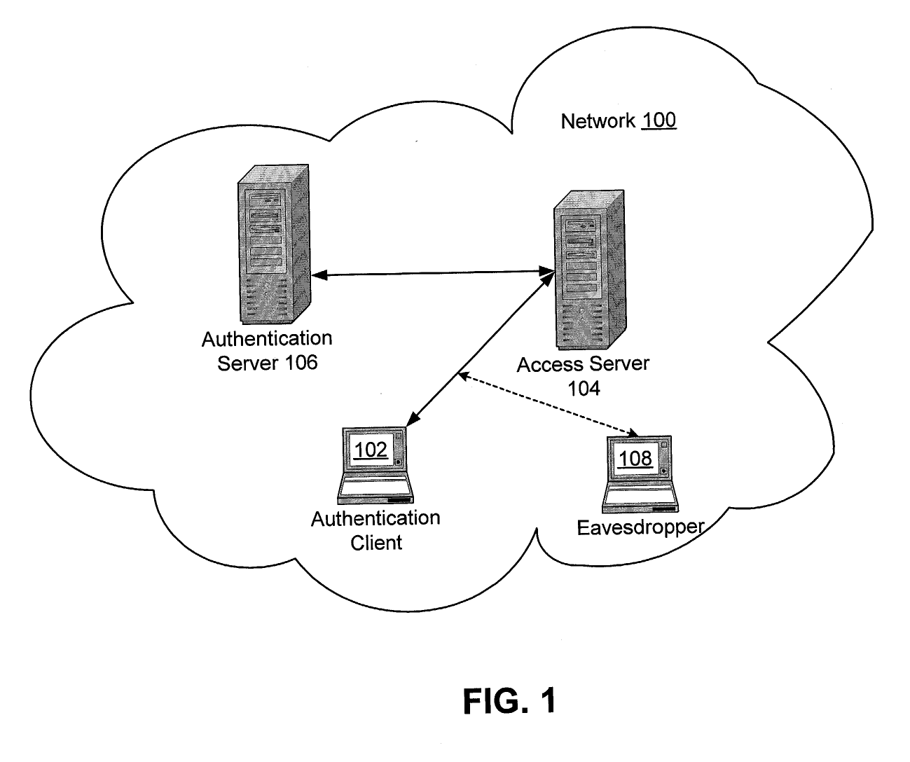

In the network environment 100 of FIG. 1, an authentication client 102 has proven its identity (“authenticated itself”) to an authentication server 106. To do this, the authentication client 102 proved to the authentication server 106 that it holds secret information presumably known only to the entity whose identity the authentication client 102 is claiming. This secret information is called the authentication client 102's “authentication credentials.”

Note that in some environments 100, especially in wireless networks, the authentication client 102 may communicate directly with a local access server 104. The access server 104 passes communications between the authentication client 102 and the authentication server 106 which may be remote and may serve several, maybe hundreds, of networks 100. The possible presence of an access server 104 does not affect the discussion of the present invention and will not be mentioned again.

Upon completion of a successful authentication, the authentication client 102 and the authentication server 106 derive a set of security keys that they can use in encrypting and authenticating messages passed between them. The security keys are derived, in part, from the authentication client 102's authentication credentials. Encryption and authentication are necessary because all messages passed within the network 100 are subject to interception by a malicious eavesdropper 108. The eavesdropper 108 intercepts the messages and applies statistical methods to them in an attempt to discover the security keys used to protect them. Because of the statistical nature of this attack, its accuracy improves with an increasing number of messages analyzed. To frustrate this statistical attack, the authentication client 102 and authentication server 106 should quickly change the security keys before the eavesdropper 108 can intercept enough messages to discover those security keys.

Known methods exist for changing the security keys. For example, during each authentication, “liveness” information, such as a random value or a timestamp, is generated. By including the liveness information along with the authentication credentials in the derivation of the security keys, a different set of security keys is derived for each successful authentication. However, each set of security keys still derives from the same authentication credentials. If those credentials are compromised, then the security keys are vulnerable to attack. To prevent this, the authentication credentials should be changed periodically, just as the security keys derived from the authentication credentials are changed frequently.

Changing the authentication client 102's authentication credentials is not as straightforward as it may at first appear. The authentication credentials may be easily changed on the authentication client 102, but, in order to be useful, that change must be coordinated with the authentication server 106. Otherwise, the authentication server 106 would still seek proof of the authentication client 102's knowledge of the old authentication credentials. (As discussed below, the authentication server 106 need not actually know these authentication credentials. The authentication server 106 can verify the authentication client 102's knowledge of the authentication credentials without knowing those credentials itself.) One simple method of coordinating the change is to send the authentication credentials over a communications link to the authentication server 106. This method is, however, not very secure, given the possible presence of the eavesdropper 108. Other known methods of coordinating the change usually involve “out-of-band” communications (methods that do not use a computer communications link). While reasonably secure, out-of-band methods may be so burdensome, especially if the authentication server 106 is located far from the authentication client 102, that they discourage frequent changes to the authentication credentials. The present invention provides a secure but non-burdensome method for the authentication client 102 and the authentication server 106 to coordinate the implementation of new authentication credentials.

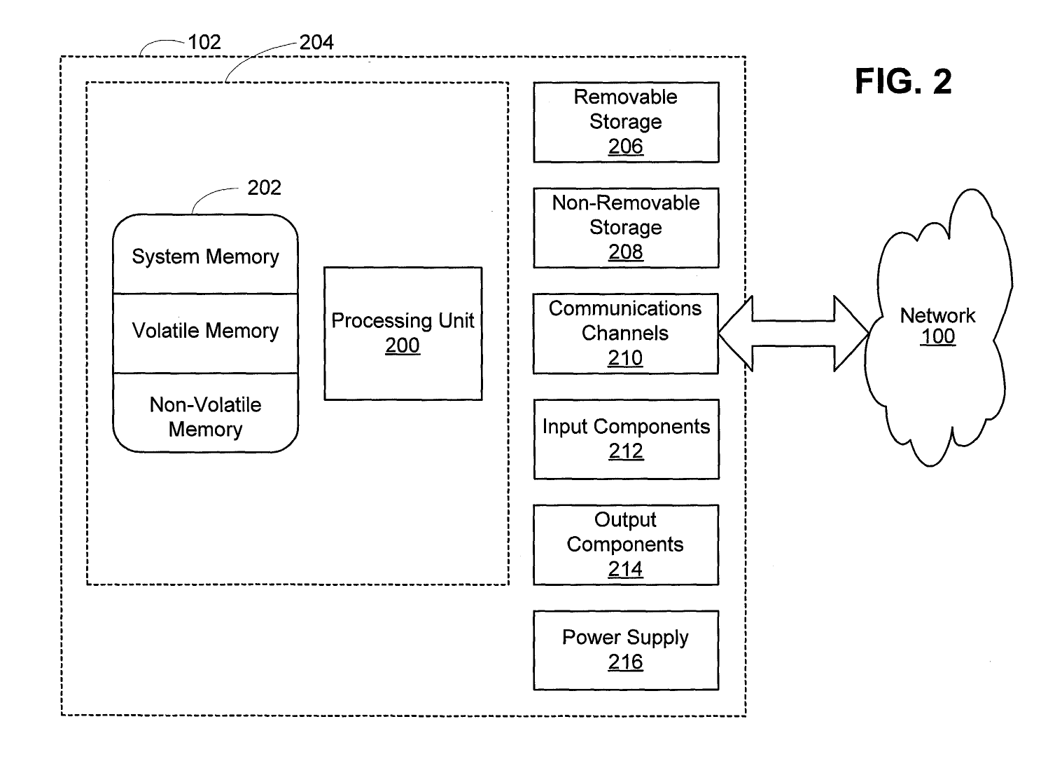

The authentication client 102 of FIG. 1 may be of any architecture. FIG. 2 is a block diagram generally illustrating an exemplary computer system that supports the present invention. The computer system of FIG. 2 is only one example of a suitable environment and is not intended to suggest any limitation as to the scope of use or functionality of the invention. Neither should the authentication client 102 be interpreted as having any dependency or requirement relating to any one or combination of components illustrated in FIG. 2. The invention is operational with numerous other general-purpose or special-purpose computing environments or configurations. Examples of well known computing systems, environments, and configurations suitable for use with the invention include, but are not limited to, personal computers, servers, hand-held or laptop devices, multiprocessor systems, microprocessor-based systems, set-top boxes, programmable consumer electronics, network PCs, minicomputers, mainframe computers, and distributed computing environments that include any of the above systems or devices. In its most basic configuration, the authentication client 102 typically includes at least one processing unit 200 and memory 202. The memory 202 may be volatile (such as RAM), non-volatile (such as ROM or flash memory), or some combination of the two. This most basic configuration is illustrated in FIG. 2 by the dashed line 204. The authentication client 102 may have additional features and functionality. For example, the authentication client 102 may include additional storage (removable and non-removable) including, but not limited to, magnetic and optical disks and tape. Such additional storage is illustrated in FIG. 2 by removable storage 206 and non-removable storage 208. Computer-storage media include volatile and non-volatile, removable and non-removable, media implemented in any method or technology for storage of information such as computer-readable instructions, data structures, program modules, or other data. Memory 202, removable storage 206, and non-removable storage 208 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the authentication client 102. Any such computer-storage media may be part of the authentication client 102. The authentication client 102 may also contain communications channels 210 that allow the device to communicate with other devices. Communications channels 210 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include optical media, wired media, such as wired networks and direct-wired connections, and wireless media such as acoustic, RF, infrared, and other wireless media. The term “computer-readable media” as used herein includes both storage media and communications media. The authentication client 102 may also have input devices 212 such as a keyboard, mouse, pen, voice-input device, touch-input device, etc. Output devices 214 such as a display, speakers, and printer may also be included. All these devices are well know in the art and need not be discussed at length here.

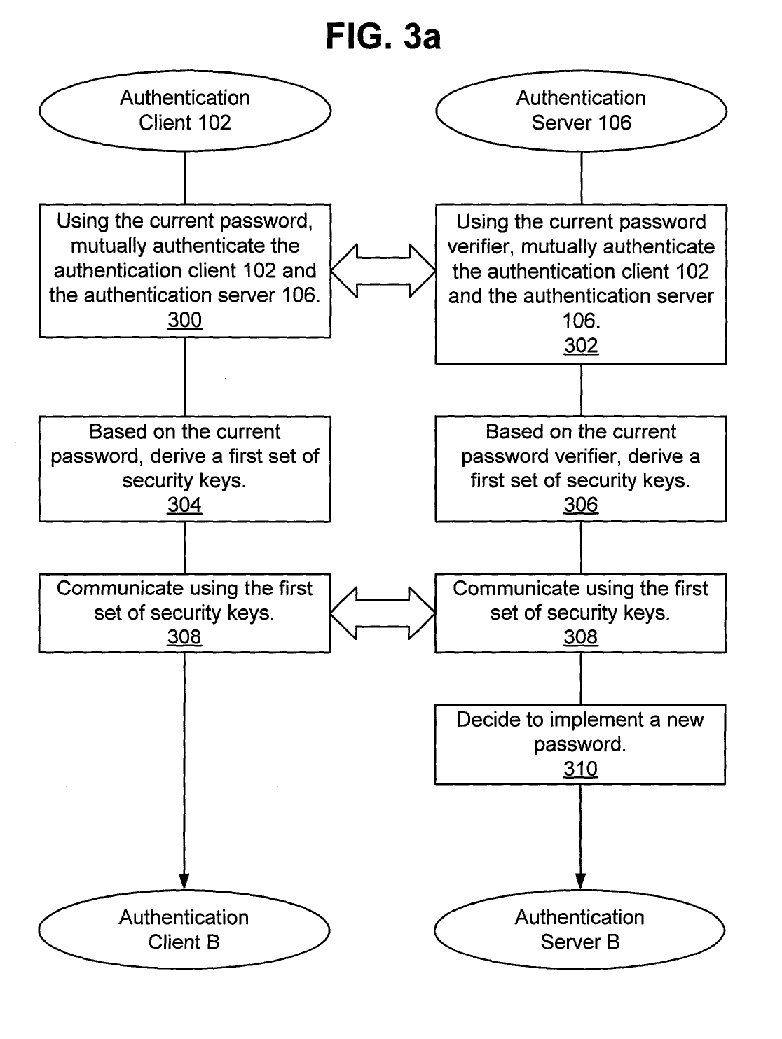

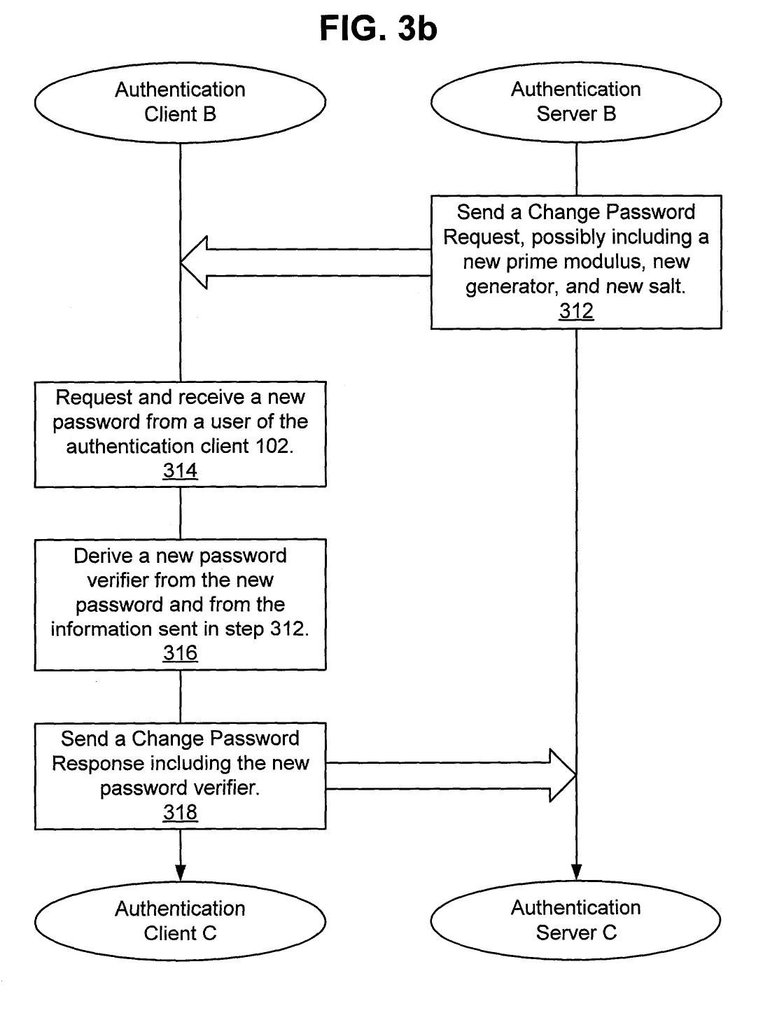

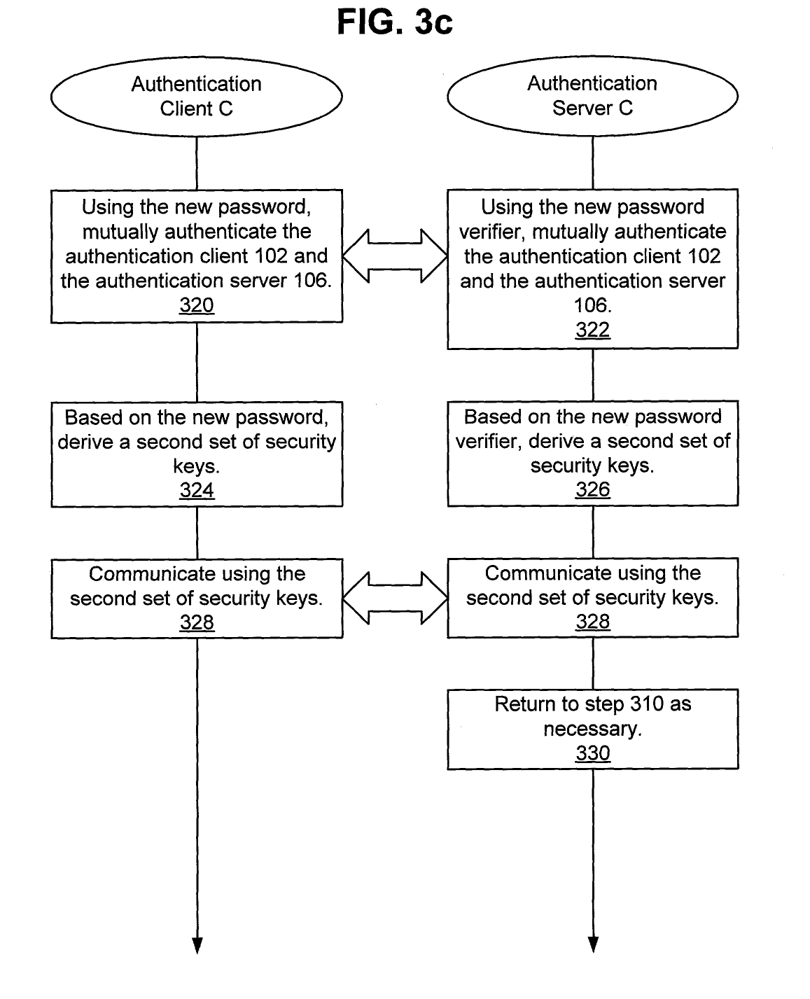

The dataflow diagram of FIGS. 3a through 3c illustrates an exemplary method for practicing the present invention. Steps 300 through 308 set the stage. In steps 300 and 302, the authentication client 102 and the authentication server 106 authenticate each other using known authentication techniques. As one example of a suitable authentication technique, consider IETF RFC (Internet Engineering Task Force Request for Comments) 2945, “The SRP Authentication and Key Exchange System,” incorporated herein in its entirety. While steps 300 and 302 mention mutual authentication, the present discussion focuses on updating the authentication credentials used in one direction of authentication. In the examples to follow, the discussion focuses on authenticating the authentication client 102 to the authentication server 106. As the methods of the invention are equally applicable to authenticating the authentication server 106 to the authentication client 102, that direction of authentication need not be discussed further.

The authentication credentials used by the authentication client 102 in step 300 include a secret password. The value of that password is probably not stored on the authentication client 102, but is entered by a user of the authentication client 102 along with a username when the user wishes to be authenticated by the authentication server 106. For security's sake, the authentication server 106 does not know the value of the secret password. It does, however, know the value of a “password verifier” derived from the secret password. The authentication server 106 stores the password verifier in association with the username. (Because the password verifier is stored in association with the username rather than in association with an identifier of the authentication client 102, it would be more proper to say that the username is authenticated rather than that the authentication client 102 is authenticated. For example, if the user moves to a different client and uses the same username and password, the authentication methods will work as before. For ease of presentation, however, the present discussion will continue to talk about authenticating the authentication client 102 to the authentication server 106.)

An example of how a password verifier may be derived from a password is discussed below in reference to step 316 of FIG. 3b. At this point in the discussion, it is sufficient to know that the derivation is both “determinative” and “irreversible.” Determinative means that there is no randomness in the derivation itself, that is, once the inputs to the derivation (which include the password but may include other values) are known, the output (the password verifier) is completely determined. That the derivation is irreversible means that the inputs cannot be determined by knowing the derivation's output. Stronger than that, if a party knows the password verifier and all of the inputs to the derivation except for the password, that party still cannot determine the password. These properties imply that, using the methods of the authentication process, only a party that knows the password itself can successfully claim to be the authentication client 102. During the authentication process, the authentication server 106 uses its knowledge of the password verifier to test the authentication client 102's knowledge of the password.

Other inputs to the derivation of the password verifier from the password are shared between the authentication client 102 and the authentication server 106. Because knowledge of these other values is insufficient to recreate the password verifier without knowledge of the password itself, these other values may be publicized before the authentication process begins and may even be set as parameters in a public-standard authentication protocol.

As one result of the authentication process, the authentication client 102, in step 304, and the authentication server 106, in step 306, in parallel derive a set of security keys. The authentication client 102 derives the security keys from the secret password, and the authentication server 106 derives them from the password verifier. A successful authentication process ensures that the security keys derived on the two devices are the same. As an example both of how an authentication process can ensure this, and of how the security keys are derived, please see IETF RFC 2246, “The TLS Protocol,” incorporated herein in its entirety.

The derivation of the security keys also involves liveness information shared between the authentication client 102 and the authentication server 106. The use of the shared liveness information in the derivation makes the security keys different every time the authentication client 102 authenticates itself to the authentication server 106. Were this not the case, the authentication client 102 would use the same security keys after every authentication. Knowing this, the eavesdropper 108 could resume its statistical attack every time the authentication client 102 is authenticated, adding newly intercepted messages to its analysis of messages intercepted during the authentication client 102's previous sessions.

The set of security keys usually includes both encryption keys (which may be either shared or may be a pair of one-way keys) and authentication keys. Once the keys are derived by the authentication client 102 and by the authentication server 106, these two devices can use the keys in step 308 to protect their communications. Examples of the use of the security keys are discussed below in reference to steps 312 and 318 of FIG. 3b. Of course, as the authentication client 102 and the authentication server 106 begin in step 308 to communicate using the security keys, the eavesdropper 108 may also begin to intercept the communications and to subject them to statistical attack in an attempt to discover the security keys (not shown).

In step 310, the authentication server 106 decides to implement a new secret password. The reasons behind that decision may typically include the amount of time that the current password has been in use, the amount of information sent under the current password, and the inherent security of the network 100. Wireless networks are usually open to eavesdropping so passwords used on these networks should be periodically changed. In any case, upon deciding that the authentication client 102's password should change, the authentication server 106 sends a request to that effect in step 312. Note that “request” is probably a euphemism in this context: if the authentication client 102 does not respond by changing its password, the authentication client 106 will probably disable the current password, preventing the authentication client 102 from authenticating itself.

As discussed above in reference to the authentication process of steps 300 and 302, the process of deriving a new password verifier may take other inputs in addition to the new password itself. The authentication server 106 may choose to send new values for these other inputs along with the change password request. This is not strictly necessary as the new password verifier may be derived from the new password and from the same values of the other inputs used the last time the password was changed. However, security is enhanced by also changing at least some of these inputs. The specific exemplary inputs listed in step 312 (prime modulus, generator, and salt) are explained below in reference to step 316. For additional security, these values may be encrypting using the security keys derived in step 306. If the change password request includes any of these other inputs, then a MAC (Message Authentication Code) covering the new inputs may also be sent. A MAC is an irreversible hash of the inputs and is usable by the authentication client 102 to check whether the contents of the change password request have been received unaltered from the authentication server 106. An example of a method for producing a MAC may be found in IETF RFC 2104, “HMAC: Keyed-Hashing for Message Authentication,” incorporated herein in its entirety.

The authentication client 102 receives the change password request along with the new input values, if any. If there are any new input values, then the MAC is verified. If the verification fails, then the change password request is ignored. Otherwise, the new values are decrypted using the same security key used to encrypt them, and the values are stored for later use. In step 314, the authentication client 314 prompts its user for a new password. For example, step 314 may take the form of the well known process wherein the user must enter the old password for authentication, then enter the new password twice for confirmation. In some embodiments, the new password may be checked against various criteria before being accepted. These criteria may include the familiar “must be at least eight characters long,” “must include both letters and numerals,” “must not be found in a standard dictionary,” “must not be a permutation of a recently used password,” “must not be the name of your spouse or pet,” etc.

When the user creates a new password that passes whatever tests the authentication client 102 may impose, the authentication client 102 derives a new password verifier from the new password in step 316. As discussed above, the derivation should be both determinative and irreversible. IETF RFC 2945 presents the following method of derivation that fulfills both requirements:

Password Verifier=G\hat{ }SHA(salt|SHA(username|“:”|password)) % P

where:

SHA (Secure Hash Algorithm) is a hash function well known in the industry;

salt is a random value shared with the authentication server 106;

| is the string concatenation operator;

username and password are entered by a user of the authentication client 102;

“:” is the string consisting of the colon character;

\hat{ } is the exponentiation operator;

% is the modulo (integer remainder) operator;

P is a “prime modulus,” a large (for security's sake, at least 512-bit) prime number shared with the authentication server 106; and

G is a generator of P shared with the authentication server 106, that is, for any natural number A less than P, there exists another number B such that G A B % P=A.

If the authentication server 106 sent new values for the prime modulus, generator, or salt in step 312, then those new values are used in the derivation of the password verifier.

The authentication client 102 takes the new password verifier, encrypts it with the security keys derived in step 306, covers it with a MAC, and sends it to the authentication server 106 in step 318. After the password verifier is successfully sent, its presence on the authentication client 102 serves no further purpose so it may be discarded. The authentication server 106 verifies the MAC, decrypts the new password verifier with the same security key used to encrypt it, and stores the new password verifier in association with the username and with any of the other inputs to the derivation process that have changed. In some embodiments, the prime modulus and generator change rarely, if ever, but a new salt is created every time the password changes.

If after a period of time, the authentication server 106 does not receive a response to its change password request, it may send the request again. As noted above, after repeated unsuccessful attempts to change the password, the authentication server 106 may decide to disable the current password.

The process of coordinating the change in authentication credentials is complete. For security's sake, it is recommended that the authentication client 102 immediately use the new credentials by re-authenticating itself in step 320 to the authentication server 106. If the re-authentication is successful, then in steps 324 and 326, paralleling steps 304 and 306, the authentication client 102 and the authentication server 106, respectively, derive a new set of security keys based on the new authentication credentials. In step 328, the new security keys are used to protect communications. The new password and new password verifier remain in use as authentication credentials until the authentication server 106 returns to step 310 by deciding to change the password yet again.

Note that the methods of the present invention allow the authentication credentials to be changed without ever interrupting communications between the authentication client 102 and the authentication server 106. These two devices continue to use the old security keys until a new set of keys is derived based on the new authentication credentials.

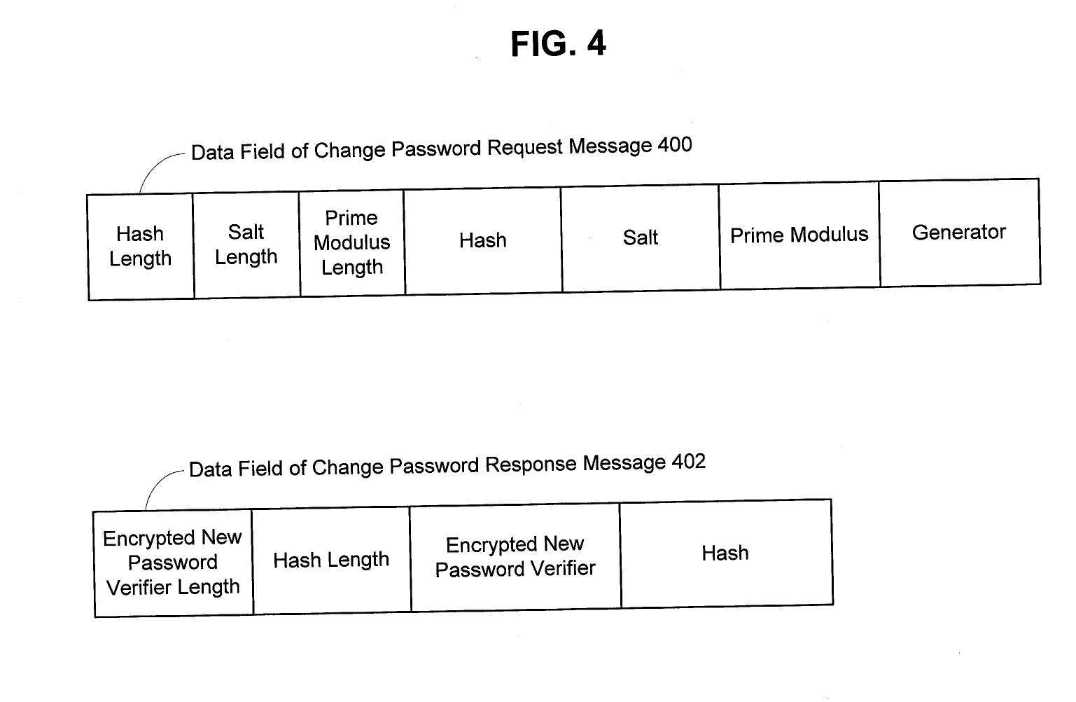

The communications protocols in use between the authentication client 102 and the authentication server 106 may determine the actual formats used to send information in steps 312 and 318. FIG. 4 gives two exemplary data structures, item 400 for a change password request message and item 402 for a change password response message. FIG. 4 only shows the data fields of the exemplary messages: the communications protocols used may add headers and trailers to these data fields. These two messages may be embodied, for example, as two new EAP-SRP (Extensible Authentication Protocol-Secure Remote Password) messages. EAP-SRP also defines a vendor-specific message that may be used to carry these data fields. Other communications protocols offer similar facilities.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details, such as data field sizes and message formats, are determined by the protocols chosen for specific situations and can be found in published standards. Although the invention is described in terms of software modules or components, some processes, especially encryption methods, may be equivalently performed by hardware components. Therefore, the invention as described herein contemplates all such embodiments as may come within the scope of the following claims and equivalents thereof.

We claim:

1. In a computing environment with an authentication client and an authentication server, the authentication client having been authenticated to the authentication server, the authenticating of the authentication client based on an old password known to the authentication client, on an old password verifier known to the authentication server, and on a username, old prime modulus, old generator of the old prime modulus, and old salt known to both the authentication client and the authentication server, a method for implementing a new password, the method comprising:
requesting, by the authentication server, that the authentication client change its password;
making accessible, by the authentication server to the authentication client, a new salt;
requesting and receiving, on the authentication client, a new password from a user of the authentication client;
computing, on the authentication client, a new password verifier, passing as inputs to the computing the new salt and the username;
making accessible, by the authentication client to the authentication server, the new password verifier; and
storing, on the authentication server, the username, new password verifier, and new salt.

2. The method of claim 1 wherein requesting that the authentication client change its password comprises sending an EAP-SRP (Extensible Authentication Protocol-Secure Remote Password) Server Change Password message and wherein making accessible the new password verifier comprises sending an EAP-SRP Client Change Password message.

3. The method of claim 1 wherein requesting that the authentication client change its password comprises sending an EAP-SRP Vendor-Specific Change Password Request message and wherein making accessible the new password verifier comprises sending an EAP-SRP Vendor-Specific Change Password Response message.

4. The method of claim 1 wherein the new salt is the same as the old salt and wherein making accessible the new salt comprises sharing, by the authentication server, the new salt with the authentication client prior to requesting that the authentication client change its password.

5. The method of claim 1 wherein the new salt is not the same as the old salt and wherein making accessible the new salt comprises using, by the authentication server, a technique selected from the group consisting of: sending a message to the authentication client containing the new salt; posting the new salt in a place accessible to the authentication server and to the authentication client; and sharing the new salt with the authentication client prior to requesting that the authentication client change its password.

6. The method of claim 5 wherein making accessible a new salt further comprises:
computing, by the authentication server, a first MAC covering the new salt, the first MAC based on an authentication-client-to-authentication-server authentication key derived during the authenticating of the authentication client;
making accessible, by the authentication server to the authentication client, the first MAC; and
computing, on the authentication client, a second MAC covering the new salt, the second MAC based on the authentication-client-to-authentication-server authentication key;
and wherein requesting and receiving a new password and computing, making accessible, and storing a new password verifier are performed only if the first MAC matches the second MAC.

7. The method of claim 1 further comprising passing as further inputs to the computing the old prime modulus and the old generator of the old prime modulus.

8. The method of claim 7 wherein computing a new password verifier comprises, on the authentication client:
assigning to a first intermediate value the results of running a hash function, the inputs to the hash function comprising the username and the new password;
assigning to a second intermediate value the results of running a hash function, the inputs to the hash function comprising the new salt and the first intermediate value;
assigning to a third intermediate value the old generator raised to a power of the second intermediate value; and
assigning to the new password verifier the third intermediate value modulo the old prime modulus.

9. The method of claim 1 wherein making accessible the new password verifier comprises:
encrypting, on the authentication client, the new password verifier using an authentication-server-to-authentication-client encryption key derived during the authenticating of the authentication client;
making accessible, by the authentication client to the authentication server, the encrypted new password verifier; and
decrypting, on the authentication server, the encrypted new password verifier using the authentication-server-to-authentication-client encryption key.

10. The method of claim 9 wherein making accessible the new password verifier further comprises:
computing, on the authentication client, a first MAC covering the encrypted new password verifier, the first MAC based on an authentication-server-to-authentication-client authentication key derived during the authenticating of the authentication client;
making accessible, by the authentication client to the authentication server, the first MAC; and
computing, on the authentication server, a second MAC covering the encrypted new password verifier, the second MAC based on the authentication-server-to-authentication-client authentication key;
and wherein storing the username, new password verifier, and new salt is performed only if the first MAC matches the second MAC.

11. The method of claim 1 further comprising:
associating, on the authentication server, a timer with the requesting that the authentication client change its password; and
if upon expiration of the timer no new password verifier is made accessible by the authentication client, then repeating, on the authentication server, the requesting that the authentication client change its password.

12. The method of claim 1 further comprising:
authenticating the authentication client to the authentication server a second time, the second authenticating based on the new password known to the authentication client, on the new password verifier known to the authentication server, and on the username, old prime modulus, old generator of the old prime modulus, and new salt known to both the authentication client and the authentication server.

13. The method of claim 1 further comprising:
making accessible, by the authentication server to the authentication client, a new prime modulus and a new generator of the new prime modulus.

14. The method of claim 13 wherein making accessible a new salt, a new prime modulus, and a new generator of the new prime modulus comprises:
computing, on the authentication server, a first MAC covering the new salt, the new prime modulus, and the new generator, the first MAC based on an authentication-client-to-authentication-server authentication key derived during the authenticating of the authentication client;
making accessible, by the authentication server to the authentication client, the first MAC; and
computing, on the authentication client, a second MAC covering the new salt, the new prime modulus, and the new generator, the second MAC based on the authentication-client-to-authentication-server authentication key;
and wherein requesting and receiving a new password and computing, making accessible, and storing a new password verifier are performed only if the first MAC matches the second MAC.

15. The method of claim 13 further comprising passing as further inputs to the computing the new prime modulus and the new generator.

16. The method of claim 15 wherein computing a new password verifier comprises, on the authentication client:
assigning to a first intermediate value the results of running a hash function, the inputs to the hash function comprising the username and the new password;
assigning to a second intermediate value the results of running a hash function, the inputs to the hash function comprising the new salt and the first intermediate value;
assigning to a third intermediate value the new generator raised to a power of the second intermediate value; and
assigning to the new password verifier the third intermediate value modulo the new prime modulus.

17. The method of claim 13 further comprising:
authenticating the authentication client to the authentication server a second time, the second authenticating based on the new password known to the authentication client, on the new password verifier known to the authentication server, and on the username, new prime modulus, new generator of the new prime modulus, and new salt known to both the authentication client and the authentication server.

18. A computer-readable medium containing instructions for performing a method for implementing a new password, an authentication client having been authenticated to an authentication server, the authenticating of the authentication client based on an old password known to the authentication client, on an old password verifier known to the authentication server, and on a username, old prime modulus, old generator of the old prime modulus, and old salt known to both the authentication client and the authentication server, the method comprising:
requesting, by the authentication server, that the authentication client change its password;
making accessible, by the authentication server to the authentication client, a new salt;
requesting and receiving, on the authentication client, a new password from a user of the authentication client;
computing, on the authentication client, a new password verifier, passing as inputs to the computing the new salt and the username;
making accessible, by the authentication client to the authentication server, the new password verifier; and
storing, on the authentication server, the username, new password verifier, and new salt.

19. In a computing environment with an authentication client and an authentication server, the authentication client having been authenticated to the authentication server, the authenticating of the authentication client based on an old password known to the authentication client, on an old password verifier known to the authentication server, and on a username, old prime modulus, old generator of the old prime modulus, and old salt known to both the authentication client and the authentication server, a method for the authentication server to cause the authentication client to implement a new password, the method comprising:
requesting that the authentication client change its password;
making accessible to the authentication client a new salt;
receiving from the authentication client a new password verifier; and
storing the username, the new password verifier, and the new salt.

20. The method of claim 19 wherein requesting that the authentication client change its password comprises sending an EAP-SRP Server Change Password message and wherein receiving from the authentication client a new password verifier comprises receiving an EAP-SRP Client Change Password message.

21. The method of claim 19 wherein requesting that the authentication client change its password comprises sending an EAP-SRP Vendor-Specific Change Password Request message and wherein receiving from the authentication client a new password verifier comprises receiving an EAP-SRP Vendor-Specific Change Password Response message.

22. The method of claim 19 wherein the new salt is the same as the old salt and wherein making accessible to the authentication client the new salt comprises sharing the new salt with the authentication client prior to requesting that the authentication client change its password.

23. The method of claim 19 wherein the new salt is not the same as the old salt and wherein making accessible to the authentication client the new salt comprises using a technique selected from the group consisting of: sending a message to the authentication client containing the new salt, posting the new salt in a place accessible to the authentication server and to the authentication client, and sharing the new salt with the authentication client prior to requesting that the authentication client change its password.

24. The method of claim 23 wherein making accessible to the authentication client a new salt further comprises:
computing a Message Authentication Code (MAC) covering the new salt, the MAC based on an authentication-client-to-authentication-server authentication key derived during the authenticating of the authentication client; and
making accessible to the authentication client the MAC.

25. The method of claim 19 wherein receiving from the authentication client a new password verifier comprises:
receiving from the authentication client an encrypted new password verifier; and
decrypting the encrypted new password verifier using an authentication-server-to-authentication-client encryption key derived during the authenticating of the authentication client.

26. The method of claim 25 wherein receiving from the authentication client a new password verifier further comprises:
receiving from the authentication client a MAC; and
computing a MAC covering the encrypted new password verifier, the MAC based on an authentication-server-to-authentication-client authentication key derived during the authenticating of the authentication client;
and wherein storing the username, the new password verifier, and the new salt is performed only if the received MAC matches the computed MAC.

27. The method of claim 19 further comprising:
associating a timer with the requesting that the authentication client change its password; and
if upon expiration of the timer no new password verifier is received from the authentication client, then repeating the requesting that the authentication client change its password.

28. The method of claim 19 further comprising:
authenticating the authentication client to the authentication server a second time, the second authenticating based on the new password known to the authentication client, on the new password verifier known to the authentication server, and on the username, old prime modulus, old generator of the old prime modulus, and new salt known to both the authentication client and the authentication server.

29. The method of claim 19 further comprising:
making accessible to the authentication client a new prime modulus and a new generator of the new prime modulus.

30. The method of claim 29 wherein making accessible to the authentication client a new salt, a new prime modulus, and a new generator of the new prime modulus comprises:
computing a MAC covering the new salt, the new prime modulus, and the new generator, the MAC based on an authentication-client-to-authentication-server authentication key derived during the authenticating of the authentication client; and
making accessible to the authentication client the MAC.

31. The method of claim 29 further comprising:
authenticating the authentication client to the authentication server a second time, the second authenticating based on the new password known to the authentication client, on the new password verifier known to the authentication server, and on the username, new prime modulus, new generator of the new prime modulus, and new salt known to both the authentication client and the authentication server.

32. A computer-readable medium containing instructions for performing a method for an authentication server to cause an authentication client to implement a new password, the authentication client having been authenticated to the authentication server, the authenticating of the authentication client based on an old password known to the authentication client, on an old password verifier known to the authentication server, and on a username, old prime modulus, old generator of the old prime modulus, and old salt known to both the authentication client and the authentication server, the method comprising:
requesting that the authentication client change its password;
making accessible to the authentication client a new salt;
receiving from the authentication client a new password verifier; and
storing the username, the new password verifier, and the new salt.

33. In a computing environment with an authentication client and an authentication server, the authentication client having been authenticated to the authentication server, the authenticating of the authentication client based on an old password known to the authentication client, on an old password verifier known to the authentication server, and on a username, old prime modulus, old generator of the old prime modulus, and old salt known to both the authentication client and the authentication server, a method for the authentication client to implement a new password, the method comprising:
receiving from the authentication server a request that the authentication client change its password;
receiving from the authentication server a new salt;
requesting and receiving a new password from a user of the authentication client;
computing a new password verifier, passing as inputs to the computing the new salt and the username; and
making accessible to the authentication server the new password verifier.

34. The method of claim 33 wherein receiving a request that the authentication client change its password comprises receiving an EAP-SRP Server Change Password message and wherein making accessible to the authentication server the new password verifier comprises sending an EAP-SRP Client Change Password message.

35. The method of claim 33 wherein receiving a request that the authentication client change its password comprises receiving an EAP-SRP Vendor-Specific Change Password Request message and wherein making accessible to the authentication server the new password verifier comprises sending an EAP-SRP Vendor-Specific Change Password Response message.

36. The method of claim 33 wherein the new salt is the same as the old salt and wherein receiving from the authentication server the new salt comprises sharing the new salt with the authentication server prior to receiving the request that the authentication client change its password.

37. The method of claim 33 wherein the new salt is not the same as the old salt and wherein receiving from the authentication server the new salt comprises using a technique selected from the group consisting of: receiving a message from the authentication server containing the new salt, accessing the new salt in a place accessible to the authentication server and to the authentication client, and sharing the new salt with the authentication server prior to receiving the request that the authentication client change its password.

38. The method of claim 37 wherein receiving from the authentication server a new salt further comprises:
receiving from the authentication server a MAC; and
computing a MAC covering the new salt, the MAC based on an authentication-client-to-authentication-server authentication key derived during the authenticating of the authentication client;
and wherein computing and making accessible to the authentication server the new password verifier are performed only if the received MAC matches the computed MAC.

39. The method of claim 33 further comprising passing as further inputs to the computing the old prime modulus and the old generator of the old prime modulus.

40. The method of claim 39 wherein computing a new password verifier comprises:
assigning to a first intermediate value the results of running a hash function, the inputs to the hash function comprising the username and the new password;
assigning to a second intermediate value the results of running a hash function, the inputs to the hash function comprising the new salt and the first intermediate value;
assigning to a third intermediate value the old generator raised to a power of the second intermediate value; and
assigning to the new password verifier the third intermediate value modulo the old prime modulus.

41. The method of claim 33 wherein making accessible to the authentication server the new password verifier comprises:
encrypting the new password verifier using an authentication-server-to-authentication-client encryption key derived during the authenticating of the authentication client; and
making accessible to the authentication server the encrypted new password verifier.

42. The method of claim 41 wherein making accessible to the authentication server the new password verifier further comprises:
computing a MAC covering the encrypted new password verifier, the MAC based on an authentication-server-to-authentication-client authentication key derived during the authenticating of the authentication client; and
making accessible to the authentication server the MAC.

43. The method of claim 33 further comprising:
authenticating the authentication client to the authentication server a second time, the second authenticating based on the new password known to the authentication client, on the new password verifier known to the authentication server, and on the username, old prime modulus, old generator of the old prime modulus, and new salt known to both the authentication client and the authentication server.

44. The method of claim 33 further comprising:
receiving from the authentication server a new prime modulus and a new generator of the new prime modulus.

45. The method of claim 44 wherein receiving from the authentication server a new salt, a new prime modulus, and a new generator of the new prime modulus comprises:
receiving from the authentication server a MAC; and
computing a MAC covering the new salt, the new prime modulus, and the new generator, the MAC based on an authentication-client-to-authentication-server authentication key derived during the authenticating of the authentication client;
and wherein computing and making accessible to the authentication server the new password verifier are performed only if the received MAC matches the computed MAC.

46. The method of claim 44 further comprising passing as further inputs to the computing the new prime modulus and the new generator.

47. The method of claim 46 wherein computing a new password verifier comprises:
assigning to a first intermediate value the results of running a hash function, the inputs to the hash function comprising the username and the new password;
assigning to a second intermediate value the results of running a hash function, the inputs to the hash function comprising the new salt and the first intermediate value;
assigning to a third intermediate value the new generator raised to a power of the second intermediate value; and
assigning to the new password verifier the third intermediate value modulo the new prime modulus.

48. The method of claim 44 further comprising:
authenticating the authentication client to the authentication server a second time, the second authenticating based on the new password known to the authentication client, on the new password verifier known to the authentication server, and on the username, new prime modulus, new generator of the new prime modulus, and new salt known to both the authentication client and the authentication server.

49. A computer-readable medium containing instructions for performing a method for an authentication client to implement a new password, the authentication client having been authenticated to the authentication server, the authenticating of the authentication client based on an old password known to the authentication client, on an old password verifier known to the authentication server, and on a username, old prime modulus, old generator of the old prime modulus, and old salt known to both the authentication client and the authentication server, the method comprising:
receiving from the authentication server a request that the authentication client change its password;
receiving from the authentication server a new salt;
requesting and receiving a new password from a user of the authentication client;
computing a new password verifier, passing as inputs to the computing the new salt and the username; and
making accessible to the authentication server the new password verifier.

50. A computer-readable medium having stored thereon a change password request data structure, the change password request data structure comprising:
a first data field containing data representing a salt;
a second data field containing data representing a prime modulus;
a third data field containing data representing a generator of the prime modulus; and
a fourth data field containing data representing a MAC covering the salt, the prime modulus, and the generator.

51. The change password request data structure of claim 50 wherein the salt, prime modulus, generator, and MAC are formatted as portions of a message selected from the group consisting of: an EAP-SRP Server Change Password message and an EAP-SRP Vendor-Specific Change Password Request message.

52. A computer-readable medium having stored thereon a change password response data structure, the change password response data structure comprising:
a first data field containing data representing a password verifier; and
a second data field containing data representing a MAC covering the password verifier.

53. The change password response data structure of claim 52 wherein the password verifier and the MAC are formatted as portions of a message selected from the group consisting of: an EAP-SRP Client Change Password message and an EAP-SRP Vendor-Specific Change Password Response message.
